(19) United States
(12) Patent Application Publication
(10) Pub. No.: US 2019/0166357 A1
(43) Pub. Date: May 30, 2019

(54) DISPLAY DEVICE, ELECTRONIC MIRROR AND METHOD FOR CONTROLLING DISPLAY DEVICE

(71) Applicant: Sharp Kabushiki Kaisha, Osaka (JP)

(72) Inventors: Takehiko Nakagawa, Sakai City (JP); Yoshimitsu Inamori, Sakai City (JP); Eri Yanagawa, Sakai City (JP); Takehiro Murao, Sakai City (JP); Ryoh Kikuchi, Sakai City (JP); Takayuki Yamada, Sakai City (JP)

(21) Appl. No.: 16/203,329

(22) Filed: Nov. 28, 2018

(30) Foreign Application Priority Data
Nov. 30, 2017 (JP) 2017-230813

(51) Int. Cl. H04N 13/359; G06T 19/00; G09G 3/00; H04N 13/31; G06F 3/01; H04N 13/366; B60R 1/00

(52) U.S. Cl. CPC H04N 13/359; G06T 19/006; G09G 3/003; B60R 1/00; G06F 3/013; H04N 13/366; H04N 13/31

(57) ABSTRACT

An aspect of the present invention provides a display device that does riot hinder driving. An electronic mirror in accordance with an embodiment of the present invention includes: a depth adjusting section for adjusting a depth of a visible object contained in an image, in a case where 2D display is switched to 3D display or in a case where 3D display is switched to 2D display; and an output image generating section for generating an image which reaches, in a predetermined time period, the depth having been adjusted by the depth adjusting section.

This Nonprovisional application claims priority under 35 U.S.C. § 119 on Patent Application No. 2017-230813 filed in Japan on Nov. 30, 2017, the entire contents of which are hereby incorporated by reference.

### TECHNICAL FIELD

The present invention relates to a display device and an electronic mirror each capable of switching between 3D display in which a 3D image (stereoscopic image) is displayed and 2D display in which a 2D image (planar image) is displayed.

### BACKGROUND ART

In recent years, there have been developed vehicles in each of which an image around the vehicle is captured by a camera mounted on the vehicle and the image thus captured is displayed on a display screen provided in front of a driver. A combination of the camera and the display screen is called an electronic mirror. Examples of the electronic mirror include a back display screen which displays an image just behind a vehicle. Further, the electronic mirror is used as a substitute for a rearview mirror or a door mirror (side mirror).

Among electronic mirrors, there are mirrors that display a 3D image (stereoscopic image) (see Patent Literatures 1 and 2). 3D images create a natural sense of depth. Therefore, a driver can intuitively and easily know a position and a speed of an object (visible object) which is displayed on the display screen. In addition, 3D images are displayed on a farther (deeper) side relative to the display screen in a sight of a driver. Accordingly, an observing point of the driver is farther in the case of 3D images as compared to 2D images. Therefore, the driver feels it easy to shift his/her eyes away from a point ahead of a vehicle to the display screen and recognize the visible object which is displayed on the display screen.

In a general display device for displaying 3D images, a right eye image age for the right eye) and a left eye image (image for the left eye) are created from one image. These right and left eye images are displayed and viewed via a parallax barrier, so that an image is stereoscopically viewed. Accordingly, in a case where a position of a right eye of a user and/or a position of a left eye of the user is/are outside a positional predetermined range, the left and right eye images cannot be viewed as a 3D image. What is even worse, inn such a case, the right and left eye images appear as overlapped images. This may hinder user's driving.

In view of the above, Patent Literature 3 discloses a display device which switches 3D image display to 2D image display so that user's driving will not be hindered, in a case where during the 3D image display, a position of a right eye of the user and/or a position of a left eye of the user moves outside a positional predetermined range.

### CITATION LIST

### Patent Literature

[Patent Literature 1] Japanese Patent Application Publication, Tokukai, No. 2013-026770 (Publication Date: Feb. 4, 2013)

[Patent Literature 2] Japanese Patent Application Publication, Tokukai, No. 2003-339060 (Publication Date: Nov. 28, 2003)

[Patent Literature 3] Japanese Patent Application Publication, Tokukai, No. 2015-215505 (Publication Date: Dec. 3, 2015)

### SUMMARY OF INVENTION

### Technical Problem

However, in a case where one of 2D image display and 3D image display are instantly switched to the other, some users may feel strange immediately after such display switching. This is because a depth of a visible object contained in an image rapidly changes. Such users are more likely to feel strange particularly in a case where 2D image display is switched to 3D image display than in a case where 3D image display is switched to 2D image display. Therefore, in a case where 2D image display is switched to 3D image display while a user is driving, the driving may be hindered. Note that a distance between a display device and the right eye of a user is substantially equal to a distance between the display device and the left eye of the user.

An object of an aspect of the present invention is to provide a display device which does not hinder driving by preventing users from feeling strange due to switching of image display at the time when one of 2D image display and 3D image display is switched to the other.

### Solution to Problem

In order to solve the above problem, a display device in accordance with an aspect of the present invention is configured to be a display device capable of switching between 2D display and 3D display, the 3D display being carried out by a parallax barrier method, the display device including: a depth adjusting section for adjusting a depth of a visible object contained in an image, in a case where the 2D display is switched to the 3D display or in a case where the 3D display is switched to the 2D display; and an image generating section for generating an image which reaches, in a predetermined time period, the depth having been adjusted by the depth adjusting section.

### Advantageous Effects of Invention

An aspect of the present invention makes it possible to provide a display device which does not hinder driving.

### BRIEF DESCRIPTION OF DRAWINGS

FIG. 1 is a block diagram schematically illustrating a configuration of an electronic mirror in accordance with Embodiment 1 of the present invention.

FIG. 2 is a view illustrating a state of a driver's seat area of a vehicle which is equipped with the electronic mirror illustrated in FIG. 1.

FIG. 3 is a top view of the vehicle illustrated in FIG. 2.

FIG. 4 is a view illustrating an example of a parallax barrier image display device which is provided in an electronic mirror illustrated in FIG. 1.

FIG. 5 is a view illustrating a distance between the image display device illustrated in FIG. 4 and both eyes of a driver.

FIG. 6 is a view for explaining some of steps in a process for displaying a 3D image by a parallax barrier method in the image display device illustrated in FIG. 4.

FIG. 7 is a view showing a case where a distance between a position of eyes and a position of a display device is appropriate in recognition of a 3D image by a parallax barrier method in the image display device illustrated in FIG. 4.

a to (c) of FIG. 8 are each a view illustrating a depth of an output image which is displayed on an image display device. (a) of FIG. 8 shows a case where the depth is zero; (b) of FIG. 8 is a case where the depth is negative; and (c) of FIG. 8 is a case where the depth is positive.

FIG. 9 is a flowchart showing a flow of a process for switching 2D display to 3D display in the electronic mirror illustrated in FIG. 1.

FIG. 10 is a block diagram schematically illustrating a configuration of an electronic mirror in accordance with Embodiment 2 of the present invention.

FIG. 11 is a flowchart showing a flow of a process for switching 3D display to 2D display in an electronic mirror in accordance with Embodiment 3 of the present invention.

### DESCRIPTION OF EMBODIMENTS

### Embodiment 1

The following description will discuss details of an embodiment of the present invention.

(Configuration of Automobile Equipped with Electronic Mirror)

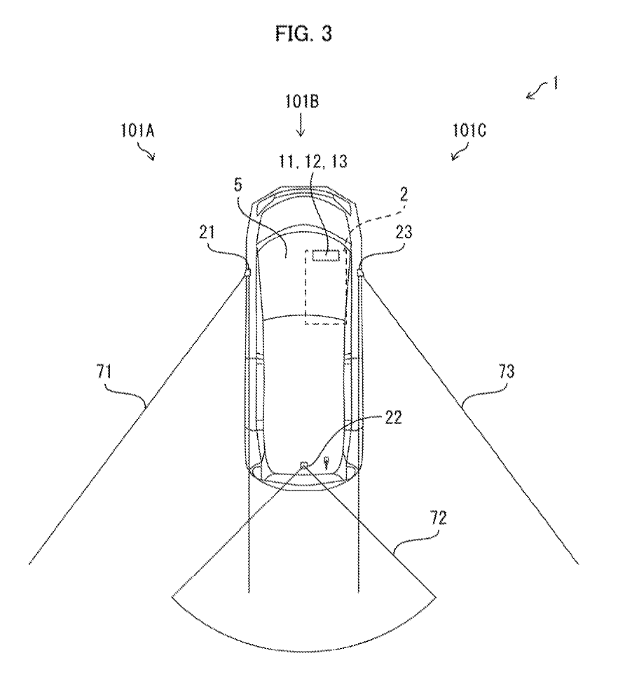

With reference to FIGS. 2 and 3, the following will discuss a display device in accordance with. Embodiment 1 of the present invention. FIG. 3 is a top view of a vehicle equipped with the display device in accordance with Embodiment 1 of the present invention. FIG. 2 is a view illustrating a state of a driver's seat area of the vehicle which is equipped with the display device in accordance with Embodiment 1 of the present invention.

Note that Embodiment 1 describes an example in which the display device in accordance with an embodiment of the present invention is mounted on a four-wheeled vehicle as an example of the vehicle. However, the vehicle equipped with the display device in accordance with an embodiment of the present invention is not limited to four-wheeled vehicles. It is possible to mount the display device in accordance with an embodiment of the present invention on various vehicles such as two-wheeled vehicles including bikes, and three-wheeled vehicles. Further, the four-wheeled vehicles are not limited to a particular kind. The display device in accordance with an embodiment of the present invention can be mounted on compact cars, middle-sized cars, large cars, trucks, buses, and the like.

Further, Embodiment 1 will describe an example in which the display device in accordance with an embodiment of the present invention is used as an electronic mirror. However, the display device in accordance with an embodiment of the present invention can be also used as various in-vehicle displays such as a display for a car navigation system.

As illustrated in FIG. 3, an automobile (vehicle) 1 includes an electronic mirror 101A for a left side of the automobile 1, an electronic mirror 101B for a rear side opposite to the front of the automobile 1, and an electric mirror 101C for a right side of the automobile 1.

The electronic mirror 101A includes a display section (display device) 11 and an image pickup section 21. The electronic mirror 101B includes a display section (display device) 12 and an image pickup section 22. The electronic mirror 101C includes a display section (display device) 13 and an image pickup section 23.

The electronic mirror 101A has a function which substitutes for a function of a left door mirror. The electronic mirror 101B has a function which substitutes for a function of a rearview mirror. The electronic mirror 101C has a function which substitutes for a function of a right door mirror. Therefore, none of the left door mirror, the rearview mirror, and the right door mirror needs to be provided in the automobile 1.

The image pickup sections 21, 22, and 23 are each an on-vehicle camera capable of capturing a moving image. The image pickup sections 21, 22, and 23 are each made of, for example, a CCD camera, a CMOS camera, or the like.

The image pickup section 21 is provided at a position where the left door mirror is typically provided, in the automobile 1. The image pickup section 21 captures a moving image in a left rear range 71 of the automobile 1, and outputs, to the display section 11, an image signal of the moving image thus captured. Note that in the automobile 1, the image pickup section 21 need only be provided at a position at which the image pickup section 21 can capture a moving image in the left rear range 71.

The image pickup section 22 is provided at a rear portion of a ceiling. The image pickup section 22 captures a moving image in a rear range 72 of the automobile 1 which rear range is opposite to the front of the automobile 1, and outputs, to the display section 12, an image signal of the moving image thus captured. Note that in the automobile 1, the image pickup section 22 need only be provided at a position at which the image pickup section 22 can capture a moving image in the rear range 72 that is opposite to the front of the automobile 1. In the automobile 1, for example, the image pickup section 22 may be provided on a rear surface where a rear bumper, a number plate, or the like is provided.

The image pickup section 23 is provided at a position where the right door mirror is typically provided, in the automobile 1. The image pickup section 23 captures a moving image in a right rear range 73 of the automobile 1, and outputs, to the display section 13, an image signal of the moving image thus captured. Note that in the automobile 1, the image pickup section 23 need only be provided at a position at which the image pickup section 23 can capture a moving image in the right rear range 73.

Note that the image pickup sections 21, 22, and 23 each can widen or narrow the left rear range 71, the rear range 72, or the right rear range 73 for image capturing by changing a field angle in capturing an image.

The display sections 11, 12, and 13 are provided inside the automobile 1. In Embodiment 1, the display sections 11, 12, and 13 are provided in a driver's seat area 2. The display section 11 displays an image of the left rear range 71 of the automobile 1, which image is captured by the image pickup section 21. The display section 11 displays the image not as a 2D (planar) image but as a 3D (depth) image. The display section 12 displays an image of the rear range 72 of the automobile 1 which rear range 72 is opposite to the front of the automobile 1. That image of the rear range 72 is an image captured by the image pickup section 22. The display section 12 displays the image as a 3D (depth) image. The display section 13 displays an image of the right rear range 73 of the automobile 1, which image is captured by the image pickup section 23. The display section 13 displays the image as a 3D (depth) image.

Accordingly, different from a case where the image obtained by capturing an image around the automobile 1 is displayed as a planar image, the above allows a driver (user) to view an image which gives the driver a sense of depth. Then, the driver can easily know a distance between visible objects in the images displayed on the display sections 11, 12, and 13, and also can easily have a sense of distance between the visible objects and the automobile 1 that the driver himself/herself is driving. In this way, the display section 11, 12, and 13 each can display an image that creates a less feeling of strangeness.

Note that the 3D (depth) image is an image which gives a sense of depth, unlike a 2D (planar) image. In particular, the 3D (depth) images displayed on the display sections 11, 12, and 13 in accordance with Embodiment 1 each not only give a sense of depth but also allow a driver to feel as if he/she were looking at a mirror.

In the driver's seat area 2 of the automobile 1, the display sections 11, 12, and 13 are provided at a position ahead of a driver in a case where the driver sits on a driver's seat. This decreases an amount of shift in sight line when the driver shifts his/her eyes to the display sections 11, 12, and 13 from a position of a visible object such as a road which the driver views through a front glass 5. This makes it possible to shorten a time for which the driver inattentively drives, in a case where the driver is to view the images displayed on the display sections 11, 12, and 13.

Further, the display section 12 is provided at a position which is in front of a driver when the driver sits on the driver's seat. Meanwhile, the driver sitting on the driver's seat sees the display section 11 provided on the left of the display section 12. Furthermore, the driver sitting on the driver's seat sees the display section 13 provided on the right of the display section 12.

On this account, the driver can intuitively know the following (1) to (3): (1) the display section 11 displays a moving image in the left rear range 71 of the automobile 1; (2) the display section 12 displays a moving image in the rear range 72 of the automobile 1, which rear range is opposite to the front of the automobile 1; and (3) the display section 13 displays a moving image in the right rear range 73 of the automobile 1.

The display sections 11, 12, and 13 are embedded in a dashboard. The automobile in accordance with Embodiment 1 also displays, on a display device 3, an instrument panel including various gauges such as a speedometer, a gauge indicating an amount of remaining fuel, and the like. The display device 3 is embedded in the dashboard. Then, the front glass 5, the display sections 11, 12, and 13, and the display device 3 are provided such that the driver sees the front glass 5, the display sections 11, 12, and 13, and the display device 3 in this order from an upper side to a lower side.

Note that the positions where the display sections 11, 12, and 13 are provided are not limited to the above-described positions. The display sections 11, 12 and 13 may be provided at any positions as long as the driver can see the display sections 11, 12, and 13 at the positions. For example, the display sections 11, 12, and 13 may be included in the display device 3. Alternatively, the display sections 11, 12, and 13 may be provided at positions where a rearview mirror is typically provided, or at an inside portion of a door.

(Details of Electronic Mirror)

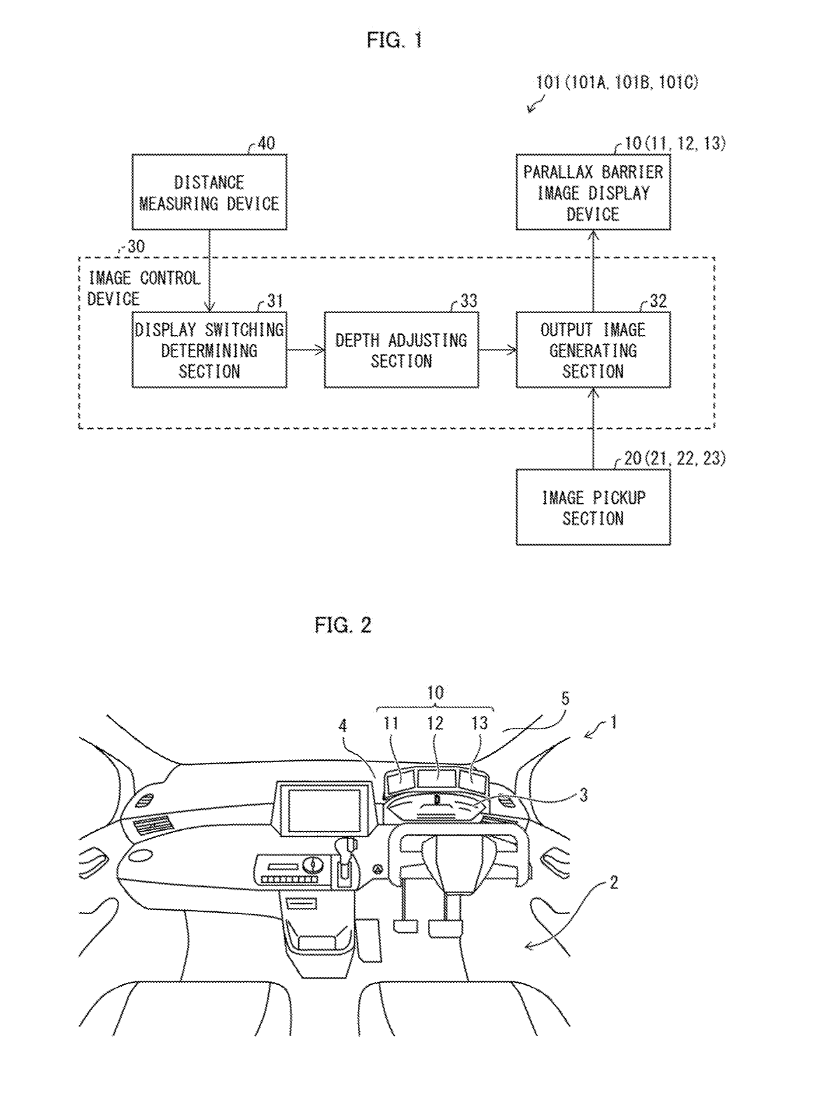

With reference to FIG. 1, the following will discuss a configuration of the electronic mirror 101 in accordance with Embodiment 1. Since the electronic mirrors 101A, 101B, and 101C illustrated in FIG. 3 have the same configuration, the electronic mirrors 101A, 101B, and 101C are collectively called an “electronic mirror 101” in the following description with reference to FIG. 1. Accordingly, in the following description with reference to FIG. 1, the display sections 11 to 13 are collectively called a parallax barrier image display device (hereinafter, referred to as “image display device”) 10, and the image pickup sections 21 to 23 are collectively called an image pickup section 20. FIG. 1 is a block diagram illustrating a configuration of the electronic mirror 101.

The electronic mirror 101 includes the parallax barrier image display device (display section) 10, the image pickup section 20, an image control device 30, and a distance measuring device 40, as illustrated in FIG. 1. The image control device 30 and the parallax barrier image display device 10 constitute a display device.

The image control device 30 obtains a captured image from the image pickup section 20. Then, the image control device 30 generates, from the captured image thus obtained, an output image to be outputted to the image display device 10. The output image contains an image for a right eye of a driver (hereinafter, referred to as right eye pixel data) and an image for a left eye of the driver (hereinafter, referred to as left eye pixel data). As illustrated in FIG. 1, the image control device 30 includes a display switching determining section 31, an output image generating section 32, and a depth adjusting section 33. Each section of the image control device 30 will be described later.

The image display device 10 displays, on a display screen, the output image which has been generated by the image control device 30. The image display device 10 may be, for example, a liquid crystal display device. Then, the output image displayed on the display screen by the image display device 10 is based on the captured image from the image pickup section 20. Meanwhile, the display device illustrated in FIG. 2 displays, on its display screen, an output image based on a digital image including information on a vehicle speed of the automobile 1, the number of engine rotations, the gear in use, and the like.

The distance measuring device 40 measures a direct distance between the display screen of the image display device 10 and both eyes of a driver who is driving the vehicle. The distance measuring device 40 sends a measurement result to the image control device 30. Details of distance measurement by the distance measuring device 40 will be described later.

(Configuration of Image Control Device 30)

As illustrated in FIG. 1, the image control device 30 includes the display switching determining section 31, the output image generating section 32, and the depth adjusting section 33. In the following description, display of a 3D image will be referred to as 3D display whereas display of a 2D image will be referred to as 2D display.

To the display switching determining section 31, the distance measuring device 40 sends a measured value of the direct distance between the display screen of the image display device 10 and both eyes of a driver. The display switching determining section 31 determines whether or not the direct distance is within a predetermined range, on the basis of the measured value of the direct distance. The display switching determining section 31 sends a result of that determination to the depth adjusting section 33. The predetermined range here means a distance range which allows the driver to appropriately view an image of the 3D display on the image display device 10. In Embodiment 1, the predetermined range is set to a range of 50 cm to 120 cm. Note that the predetermined range is not limited to the range of 50 cm to 120 cm. The predetermined range varies depending on various conditions such as a display screen size of the image display device 10.

The depth adjusting section 33 adjusts a depth of an output image generated by the output image genera g section 32. The depth of the output image is a parameter indicative of a depth of a position of a visible object in the output image (i.e., a parameter indicative of a distance from a display screen to the visible object) in a view of a driver. The depth may be a positive or negative value or zero. In Embodiment 1, the depth adjusting section 33 adjusts a pixel shift amount Δpix (amount of pixel shift) between right eye pixel data and left eye pixel data, depending on a set depth of the output image.

When the depth adjusting section 33 receives, from the display switching determining section 31, a determination result which instructs to switch from 2D display to 3D display, the depth adjusting section 33 sends, to the output image generating section 32, a signal which is adjusted so that the pixel shift amount Δpix for carrying out 3D display will be achieved in a predetermined time period.

The output image generating section 32 generates an output image by alternately arranging the left eye pixel data and the right eye pixel data from one captured image. Next, the output image generating section 32 generates an image in accordance with the signal from the depth adjusting section 33 so that the pixel shift amount Δpix for carrying out the 3D display will be achieved in the predetermined time period. Then, the output image generating section 32 sends the signal thus generated to the image display device 10. In this case, when the predetermined time period is, for example, a period of two frames, pixels corresponding to the left eye pixel data and pixels corresponding to the right eye pixel data are shifted from each other by Δpix/2 in each frame, so that the pixel shift amount Δpix in total is ultimately achieved in a period of two frames. Then, the 3D display is ultimately carried out. Note that a method of generating an image in the 3D display is a general method, and therefore an explanation of details thereof will be omitted here.

(Arrangement of Image Display Device 10)

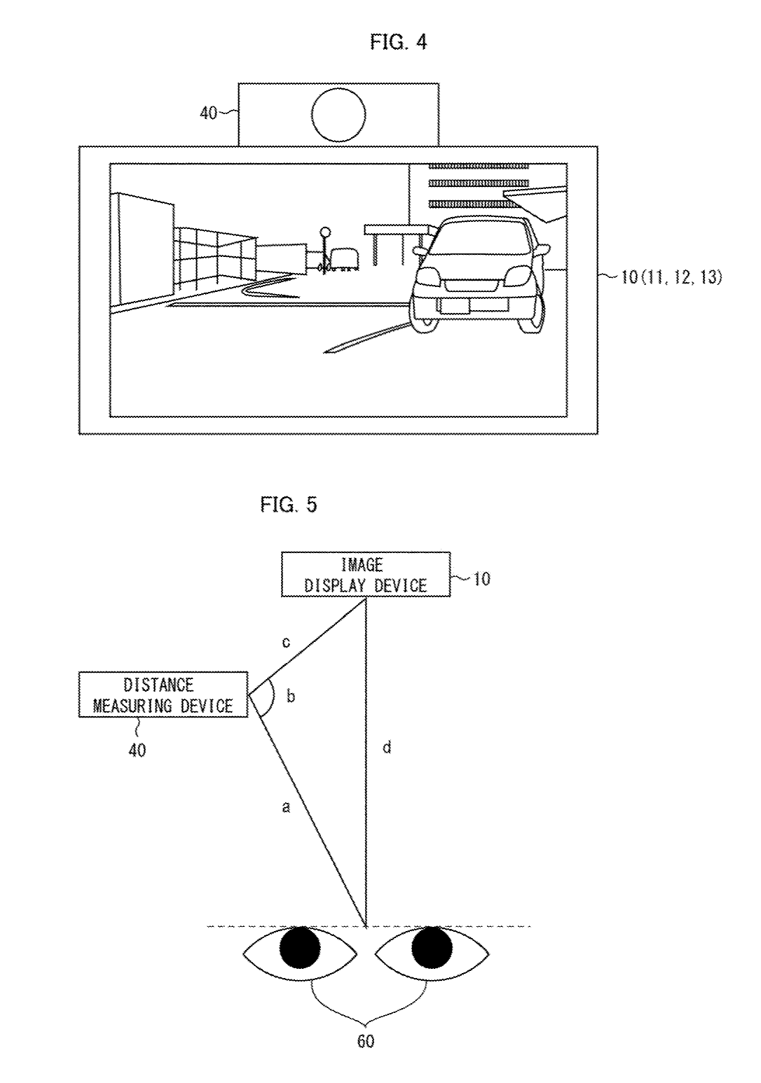

FIG. 4 shows an example of how the image display device 10 and the distance measuring device 40 are arranged. In this example, the image display device 10 and the distance measuring device 40 are integrated into one unit. In other words, a position of the distance measuring device 40 for measuring a distance to both eyes of a driver is substantially the same as a position of the image display device 10 which the drive (user) views. In this case, when the image display device 10 vibrates, the distance measuring device 40 similarly vibrates. Accordingly, an amplitude of vibration of the image display device 10 is equal to that of the distance measuring device 40. Therefore, the distance to the both eyes of the driver can be appropriately measured by use of the distance measuring device 40.

Further, when the image display device 10 and the distance measuring device 40 are integrated into one unit, the distance between the image display device 10 and eyes of a driver is equal to a distance between the distance measuring device 40 and the eyes of the driver. Accordingly, the distance measured by the distance measuring device 40 can directly be the distance between the image display device 10 and the eyes of the driver. In this case, the distance measuring device 40 can be a device such as a monocular camera or a stereo camera. In a case where the monocular camera is used, a distance between the monocular camera and both eyes of a driver is defined as a reference distance and an area of the both eyes of the driver in that case is measured in advance. Then, a distance to an object to be measured can be calculated on the basis of an area of the both eyes in a captured image. Note that the distance measuring device 40 may be a device which utilizes infrared to measure a distance to an object to be measured.

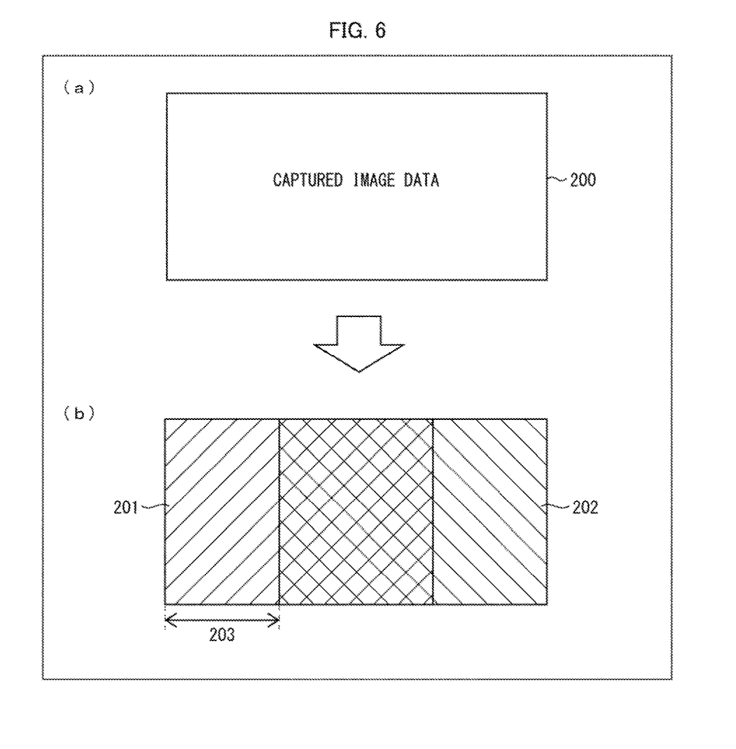

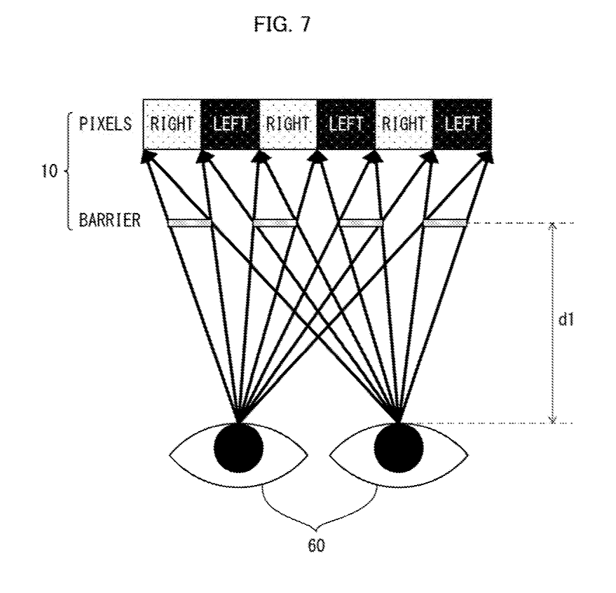

Note that an embodiment of the present invention is not limited to a structure in which the image display device 10 and the distance measuring device 40 are integrated into one unit. The image display device 10 and the distance measuring device 40 may be provided at separate positions, respectively. In such a case, the distance between the image display device 10 and both eyes of a driver may be measured by using the law of cosines as illustrated in FIG. 5.

That is, when the distance between the image display device 10 and both eyes 60 of a driver is to be measured by the distance measuring device 40, a three-dimensional (x, y, z) distance between the distance measuring device 40 and the image display device 10 is fixed in advance. Then, the distance between the image display device 10 and the both eyes 60 of the driver is calculated by measuring the distance between the distance measuring device 40 and the both eyes 60 of the driver.

Specifically, a positional relation (distance a) between the distance measuring device 40 and the both eyes 60 of the driver is measured in a three-dimensional coordinate system by use of the distance measuring device 40. In this case, positions of the distance measuring device 40 and the image display device 10 are fixed in advance (that is, a distance c is fixed in advance). Accordingly, a positional relation between the image display device 10 and the distance measuring device 40 in the three-dimensional coordinate system is known in advance in the distance measuring device 40. When coordinates of the both eyes 60 and coordinates of the distance measuring device 40 are found, a side a, a side b, and an angle b as shown in FIG. 5 are known, so that a distance d is calculated by the law of cosines. The distance d thus calculated is sent to the display switching determining section 31.

In a case where the distance d calculated by the distance measuring device 40 is within a predetermined range (a range in which an image in 3D display is appropriately viewed) while the 3D display is being carried out, the display switching determining section 31 instructs the output image generating section 32 to keep the 3D display. In contrast, in a case where the distance d is outside the above predetermined range while the 3D display is being carried out, the display switching determining section 31 instructs the output image generating section 32 to switch the 3D display to 2D display.

Note that in a case where the distance d calculated by the distance measuring device 40 is within the predetermined range (the range in which an image in 3D display is appropriately viewed) while 2D display is being carried out, the display switching determining section 31 may instruct the output image generating section 32 to switch the 2D display to 3D display. In contrast, in a case where the distance d is outside the above predetermined range while the 2D display is being carried out, the display switching determining section 31 may instruct the output image generating section 32 to keep the 2D display.

(3D Display by Parallax Barrier Method)

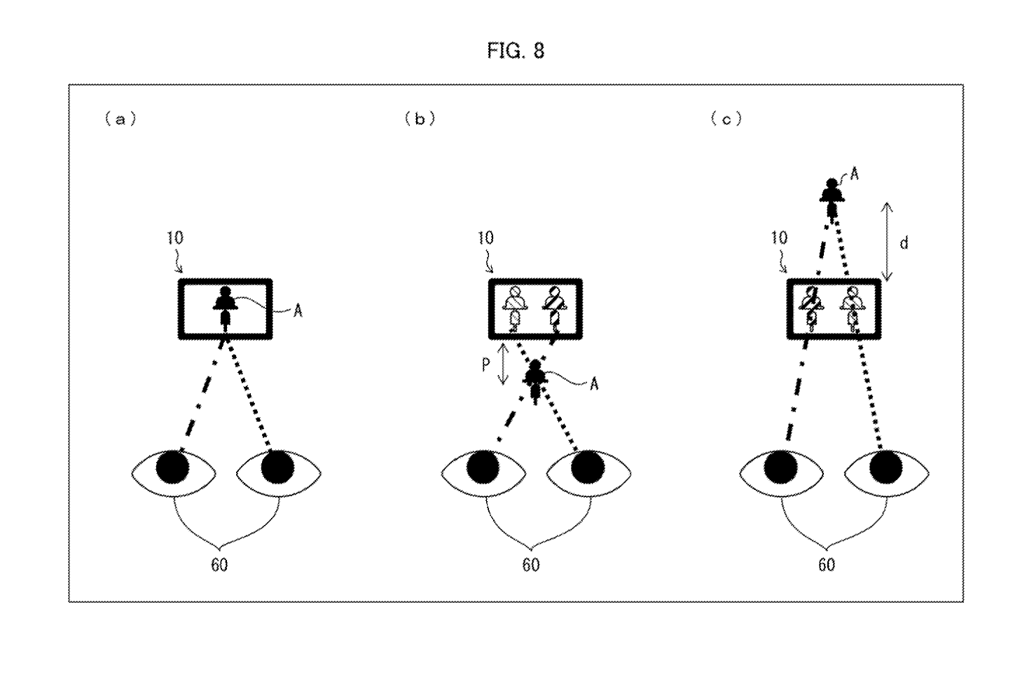

The following will discuss 3D display by a parallax barrier method, with reference to FIGS. 6 and 7.

The output image generating section 32 generates left eye pixel data and right eye pixel data from image data 200 illustrated in (a) of FIG. 6 which has been captured by the image pickup section 20. In this case, as illustrated in (b) of FIG. 6, a viewing angle range 201 of the left eye pixel data and a viewing angle range 202 of the right eye pixel data are shifted by a predetermined number of pixels. As a shift amount 203 of viewing angle range increases, a visible object contained in the image data 200 is viewed at a larger depth. In other words, as the shift amount 203 increases, a resultant 3D image has a larger depth.

As illustrated in FIG. 7, the left eye pixel data and the right eye pixel data are alternately arranged and displayed. In this configuration, when a 3D image is viewed from a position where a distance d1 from both eyes 60 of a driver to the barrier (image display device 10) is appropriate, the driver can appropriately view the 3D image. That is, when the 3D image is viewed through a barrier from a position where only the left eye pixel data is viewable to the left eye of the driver and only the right eye pixel data is viewable to the right eye of the driver, the driver can appropriately view the 3D image.

The pixel shift amount Δpix between the left eye pixel data and the right eye pixel data in 3D display is obtained as follows.

(Method of Setting Pixel Shift Amount Δpix)

With reference to (a) to (c) of FIG. 8, the following will discuss how the depth adjusting section 33 sets the pixel shift amount Δpix between the right eye pixel data and the left eye pixel data which are described above. (a) to (c) of FIG. 8 illustrate a display screen of the image display device 10 on which display screen an output image is being displayed. In (a) to (c) of FIG. 8, the right eye of a driver views only an image for the right eye, which image is created by the right eye pixel data contained in the output image. Meanwhile, the left eye of the driver views only an image for the left eye, which image is created by the left eye pixel data contained in the output image. The driver recognizes as if a visible object A were present at a position where a line of sight of the right eye and a line of sight of the left eye illustrated in each of (a) to (c) of FIG. 8 intersect with each other.

(a) of FIG. 8 illustrates the output image in a case where the depth is 0, that is, in a case where the pixel shift amount Δpix is zero. In this case, the driver views the visible object A on the display screen of the image display device 10. That is, the driver views the output image as in a case where the 2D image is displayed on the image display device 10.

(b) of FIG. 8 illustrates an output image in a case where the depth is negative, that is, in a case where the pixel shift amount Δpix is negative. The visible object A in this case appears to pop out of the display screen of the image display device 10. The depth of the output image in this case is expressed as a pop-out length p. As illustrated in (b) of FIG. 8, in a case where the depth is negative, the driver views the visible object A nearer than the display screen of the image display device 10. In this case, the driver feels as if the visible object A were popping out of the display screen of the image display device 10.

(c) of FIG. 8 illustrates the output image in a case where the depth is positive, that is, in a case where the pixel shift amount Δpix is positive. In this case, the depth of the output image is expressed as a depth length d. As illustrated in (c) of FIG. 8, in a case where the depth is positive, the driver views the visible object A farther than the display screen of the image display device 10. In this case, an observing point of the driver is farther than the display screen of the image display device 10.

The depth adjusting section 33 obtains a pixel shift amount Δpix of a case illustrated in one of (a) to (c) of FIG. 8, on the basis of a determination result from the display switching determining section 31. Then, the depth adjusting section 33 generates a signal which is adjusted so that the pixel shift amount Δpix for carrying out 3D display will be achieved in a predetermined time period. Further, the depth adjusting section 33 sends the signal to the output image generating section 32.

(Switching from 2D Display to 3D Display)

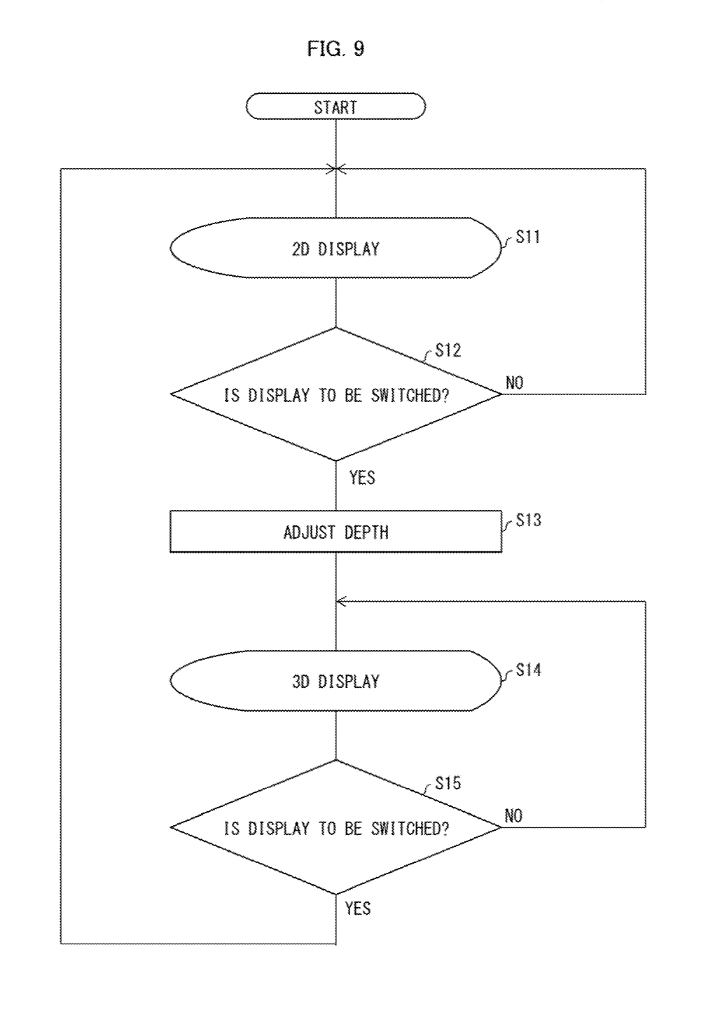

FIG. 9 is a flowchart showing a flow of a process for switching 2D display to 3D display.

First, during 2D display (step S11), it is determined whether or not there is an instruction to switch to 3D display (step S12). If it is determined that there is an instruction to switch to 3D display (YES in step S12), the depth adjusting section 33 carries out a depth adjustment process (step S13: depth adjusting step, the step of adjusting a depth).

The depth adjustment process is a process for generating a signal which is adjusted so that the pixel shift amount Δpix for carrying out 3D display will be achieved in a predetermined time period. The predetermined time period here is two frames. Note, however, that the predetermined time period is not limited to two frames.

When the depth adjustment process is carried out in step S13, the output image generating section 32 generates an image signal for carrying out the 3D display. Then, the output image generating section 32 outputs this image signal for the 3D display to the image display device 10 (step S14: image generating step, the step of generating an image). The 3D display in this case is carried out such that pixels corresponding to the left eye pixel data and pixels corresponding to the right eye pixel data are shifted from each other from zero to the pixel shift amount Δpix in the predetermined time period (two frames).

Subsequently, the image control device 30 determines whether or not there is an instruction to switch from the 3D display to 2D display (step S15). Here, if there is an instruction to switch from the 3D display to 2D display (YES in step S15), the process moves on to step S11 and causes the image display device 10 to carry out 2D display.

As described above, in a case where there is an instruction to switch to 3D display during 2D display, an image is generated such that the image reaches, in a predetermined time period, a depth (pixel shift amount Δpix) which has been adjusted by the depth adjusting section 33. This makes it possible to gradually change the depth in switching from 2D display to 3D display. This consequently makes it possible to reduce a feeling of strangeness, which is caused by a rapid change in depth of a visible object when switching from 2D display to 3D display is carried out. Therefore, a driver can view a visible object(s) contained in an image without a feeling of strangeness, and can safely drive a vehicle.

### Embodiment 2

The following description will discuss details of another embodiment of the present invention. Note that, for convenience of explanation, identical reference numerals are given to members which have respective functions identical with those described in the above Embodiment 1, and descriptions of the respective members will not be repeated.

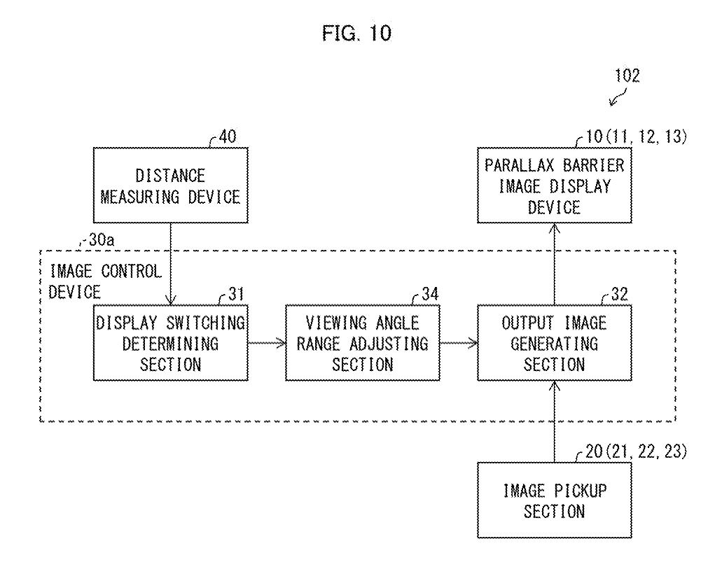

FIG. 10 is a block diagram schematically illustrating a configuration of an electronic mirror 102 in accordance with Embodiment 2. As illustrated in FIG. 10, the electronic mirror 102 in accordance with Embodiment 2 is mostly identical in configuration to the electronic mirror 101 in accordance with Embodiment 1, but is different in an image control device 30a from the electronic mirror 101. In other words, the image control device 30a is configured to include a viewing angle range adjusting section 34 in place of the depth adjusting section 33 in the image control device 30 in accordance with the above Embodiment 1.

The viewing angle range adjusting section 34 adjusts a viewing angle range of an output image which is generated by the output image generating section 32. The viewing angle range of the output image which has been captured by a monocular device is usually arranged to be different between an output image in 2D display and an output image in 3D display. For example, when 2D display of a full image captured is carried out, the viewing angle range in this 2D display is wider by the pixel shift amount Δpix than a viewing angle range in 3D display. Such difference in viewing angle range causes a feeling of strangeness at the time of display switching. Accordingly, the viewing angle range adjusting section 34 sends, to the output image generating section 32, a signal which is adjusted so that the viewing angle range will be the same for both 2D display and 3D display.

In accordance with the signal from the viewing angle range adjusting section 34, the output image generating section 32 generates an image such that the viewing angle range is the same for both 3D display device and 2D display. Then, the output image generating section 32 sends the image to the image display device 10. In other words, in a case where one of 2D display and 3D display is switched to the other, the output image generating section 32 generates an image for 2D display or 3D display such that the viewing angle range is unchanged.

As described above, in a case where one of 2D display and 3D display is switched to the other, an image for 2D display or 3D display is generated such that the viewing angle range is unchanged. Then, the viewing angle range of a generated image stays the same regardless of whether the image is for the 3D display or the 2D display. This makes it possible to reduce a feeling of strangeness, which is caused by a change in viewing angle range at the time of display switching.

Note that Embodiments 1 and 2 above have described the depth and the viewing angle range at the time of display switching. The following Embodiment 3 will discuss an example of a trigger for switching from 3D display to 2D display.

### Embodiment 3

The following description will discuss details of still another embodiment of the present invention. Note that, for convenience of explanation, identical reference numerals are given to members which have respective functions identical with those described in the above Embodiment 1 or 2, and descriptions of the respective members will not be repeated.

An electronic mirror in accordance with Embodiment 3 is substantially identical in configuration to that in accordance with Embodiment 1 or 2, but is different in a display switching determining process in a display switching determining section 31 of an image control device 30 or 30a, In particular, a process for switching from 3D display to 2D display is different.

(Switching from 3D Display to 2D Display)

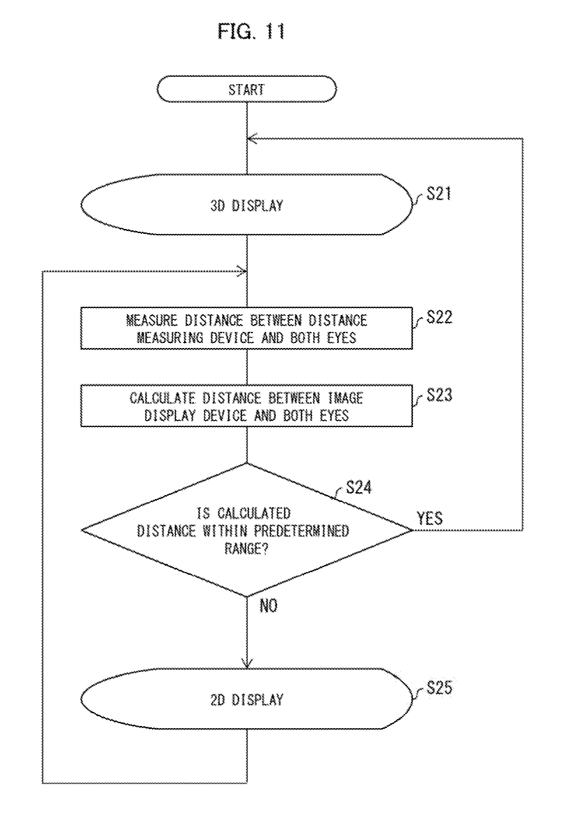

FIG. 11 is a flowchart showing a flow of a process for switching 3D display to 2D display. Note that the following describes an example in which an image display device 10 and a distance measuring device 40 are provided at separate positions, respectively, as illustrated in FIG. 5.

First, during 3D display (step S21), a distance between a distance measuring device 40 and both eyes 60 is measured (step S22). The distance measuring device 40 here captures an image of the both eyes 60, and calculates the distance from the distance measuring device 40 to the both eyes 60 on the basis of an area of the both eyes 60. Specifically, in a case where the distance measuring device 40 is a monocular camera, a distance between the monocular camera and both eyes 60 of a driver is defined as a reference distance and an area of the both eyes 60 of the driver in that case is measured in advance. Then, the distance from the distance measuring device 40 to the both eyes 60 is measured on the basis of an area of the both eyes 60 in a captured image and the area of the both eyes 60 of the driver which area has been measured in advance.

Next, a distance between the image display device 10 and the both eyes 60 is calculated on the basis of the distance from the distance measuring device 40 to the both eyes 60 (Step S23). This calculation of the distance is performed by using the law of cosines as illustrated in FIG. 5.

Next, it is determined whether or not the distance (calculated distance) calculated in step S23 is in a predetermined range (step S24). Here, in a case where the distance thus calculated is within the predetermined range (YES in step S24), the process moves on to step S21 and the 3D display is continued. In contrast, in a case where the calculated distance is outside the predetermined range (NO in step S24), the 3D display is switched to 2D display and the process moves on to step S22. Then, the distance between the distance measuring device 40 and the both eyes 60 is measured again.

As described above, in a case where the distance between the image display device 10 and the both eyes 60 falls outside the predetermined range during 3D display, for example, in a case where the both eyes 60 come too close to the image display device 10, the 3D display is switched to 2D display. In this way, in a case where the distance between the parallax barrier (image display device 10) and the both eyes 60 of a driver falls outside the predetermined range during 3D display, the 3D display is changed to 2D display. This allows the driver to correctly view a visible object(s) contained in an image and to safely drive a vehicle.

[Software Implementation Example]

Control blocks of the electronic mirror 101 or 102 (particularly, the image control device 30 and the image control device 30a) may be realized by a logic circuit (hardware) provided in an integrated circuit (IC chip) or the like or may be realized by software.

In the latter case, the electronic mirror 101 or 102 includes a computer that executes instructions of a program that is software realizing the foregoing functions. This computer includes, for example, at least one processor (control device) and at least one computer readable storage medium in which the program is stored. The object of the present invention can be achieved by the processor reading and executing the program stored in the storage medium in the computer. Note that the process can be, for example, a Central Processing Unit (CPU). The storage medium may be “a non-transitory tangible medium” such as a Read Only Memory (ROM), a tape, a disk, a card, a semiconductor memory, and a programmable logic circuit. Further, the storage medium may further include a Random Access Memory (RAM) that develops the program in executable form. Further, the program may be supplied to or made available to the computer via any transmission medium (such as a communication network and a broadcast wave) which enables transmission of the program. Note that an aspect of the present invention can also be implemented by the program in the form of a computer data signal embedded in a carrier wave which is embodied by electronic transmission.

[Recap]

A display device in accordance with Aspect 1 of the present invention is a display device capable of switching between 2D display and 3D display, the 3D display being carried out by a parallax barrier method, the display device including: a depth adjusting section 33 for adjusting a depth of a visible object contained in an image, in a case where the 2D display is switched to the 3D display or in a case where the 3D display is switched to the 2D display; and an image generating section (output image generating section 32) for generating an image which reaches, in a predetermined time period, the depth having been adjusted by the depth adjusting section 33.

In the above configuration, an image is generated which image reaches, in the predetermined time period, the depth which has been adjusted by the depth adjusting section. This makes it possible to gradually change the depth in switching between the 2D display and the 3D display. This consequently makes it possible to reduce a feeling of strangeness, which is caused by a rapid change in depth of a visible object when switching between the 2D display and the 3D display is carried out. Therefore, when the display device is mounted to an on-vehicle electronic mirror, user's driving is not hindered.

A display device in accordance with Aspect 2 of the present invention may be configured such that, in the above Aspect 1: the image generating section (output image generating section 32) generates right eye pixel data and left eye pixel data from the image; and pixels corresponding to the right eye pixel data and pixels corresponding to the left eye pixel data are shifted from each other so as to reach, in the predetermined time period, a pixel shift amount corresponding to the depth which has been adjusted by the depth adjusting section 33.

In the above configuration, the pixels corresponding to the right eye pixel data and the pixels corresponding to the left eye pixel data are shifted from each other so as to reach, in the predetermined time period, the pixel shift amount corresponding to the depth which has been adjusted by the depth adjusting section. This makes it possible to gradually change the depth in switching between the 2D display and the 3D display. Further, the above configuration makes it possible to reduce a feeling of strangeness, which is caused by a rapid change in depth of a visible object when switching between 2D display and 3D display is carried out. Therefore, when the display device is mounted to an on-vehicle electronic mirror, user's driving is not hindered.

The display device in accordance with Aspect 3 of the present invention may be configured such that, in the above Aspect 1 or 2, the predetermined time period for switching from the 2D display to the 3D display is longer than the predetermined time period for switching from the 3D display to the 2D display.

It is when display is switched from the 2D display to the 3D display that a strong feeling of strangeness is created due to instant display switching. In light of this, as in the above configuration, the predetermined time period for switching from the 2D display to the 3D display is arranged to be longer than the predetermined time period for switching from the 3D display to the 2D display. Then, such a feeling of strangeness can be reduced at the time of display switching.

A display device in accordance with Aspect 4 of the present invention may be configured such that, in any one of the above Aspects 1 to 3, in a case where one of the 2D display and the 3D display is switched to another one of the 2D display and the 3D display, the image generating section (output image generating section 32) generates an image for the 2D display or the 3D display such that the viewing angle range is unchanged.

In the above configuration, in a case where one of 2D display and 3D display is switched to the other, an image for 2D display or 3D display is generated such that the viewing angle range is unchanged. Then, the viewing angle range of a generated image does not change between the 3D display and the 2D display. This makes it possible to reduce a feeling of strangeness, which is caused by a change in viewing angle range at the time of display switching.

An electronic mirror in accordance with Aspect 5 of the present invention is configured to include: a display device as described in any one of the above Aspects 1 to 4; and an image pickup section 20 for capturing an image of a front side, a rear side opposite to the front side, a right rear side, or a left rear side of a vehicle, and outputting the image thus captured to the display device.

The above configuration allows a driver driving the vehicle to avoid hindrance to the driving.

A method for controlling a display device in accordance with Aspect 6 of the present invention is a method for controlling a display device including a display section capable of switching between 2D display and 3D display, the 3D display being carried out by a parallax barrier method, said method including the steps of: adjusting a depth of a visible object contained in an image, in a case where the 2D display is switched to the 3D display or in a case where the 3D display is switched to the 2D display; and generating an image which reaches, in a predetermined time period, the depth having been adjusted in the step of adjusting the depth. The above configuration produces an effect similar to that of the display device in accordance with the above Aspect 1 of the present invention.

The steps of the display method as described in the above Aspect 6 of the present invention may be each realized by a computer.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

10 image display device
11, 12, 13 display section
20 image pickup section
21, 22, 23 image pickup section
30, 30a image control device
31 display switching determining section
33 output image generating section
33 depth adjusting section
34 viewing angle range adjusting section
40 distance measuring device
60 both eyes
101, 101A, 101B, 101C electronic mirror
102 electronic mirror
200 image data
201 viewing angle range
202 viewing angle range
A visible object

1. A display device capable of switching between 2D display and 3D display, the 3D display being carried out by a parallax barrier method, the display device comprising:
a depth adjusting section for adjusting a depth of a visible object contained in an image, in a case where the 2D display is switched to the 3D display or in a case where the 3D display is switched to the 2D display; and
an image generating section for generating an image which reaches, in a predetermined time period, the depth having been adjusted by the depth adjusting section.

2. The display device as set forth in claim 1, wherein:
the image generating section generates right eye pixel data and left eye pixel data from the image; and
pixels corresponding to the right eye pixel data and pixel corresponding to the left eye pixel data are shifted from each other so as to reach, in the predetermined time period, a pixel shift amount corresponding to the depth which has been adjusted by the depth adjusting section.

3. The display device as set forth in claim 1, wherein:
the predetermined time period for switching from the 2D display to the 3D display is longer than the predetermined time period for switching from the 3D display to the 2D display.

4. The display device as set forth in claim 1, wherein:
in a case where one of the 2D display and the 3D display is switched to another one of the 2D display and the 3D display, the image generating section generates an image for the 2D display or the 3D display such that the viewing angle range is unchanged.

5. An electronic mirror comprising:
a display device as recited in claim 1; and
an image pickup section for capturing an image of a front side, a rear side opposite to the front side, a right rear side, or a left rear side of a vehicle, and outputting the image thus captured to the display device.

6. A method for controlling a display device including a display section capable of switching between 2D display and 3D display, the 3D display being carried out by a parallax barrier method, said method comprising the steps of:
adjusting a depth of a visible object contained in an image, in a case where the 2D display is switched to the 3D display or in a case where the 3D display is switched to the 2D display; and
generating an image which reaches, in a predetermined time period, the depth having been adjusted in the step of adjusting the depth.
